(19) United States
(12) Patent Application Publication
(10) Pub. No.: US 2009/0286934 A1
(43) Pub. Date: Nov. 19, 2009

(54) UV STABILIZER FOR PMMA

(75) Inventors: Thorsten Goldacker, Wiesbaden (DE); Klaus Koralewski, Riedstadt (DE); Alexander Laschitsch, Frankfurt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: RÖHM GMBH, Darmstadt (DE)

(21) Appl. No.: 11/721,979

(22) PCT Filed: Oct. 29, 2005
(86) PCT No.: PCT/EP2005/011615

§ 371 Date: Jun. 16, 2007

(30) Foreign Application Priority Data
Dec. 16, 2004 (DE) 10 2004 061 126.2

(51) Int. Cl. C08F 20/10; C08F 112/08; C08F 20/44

(52) U.S. Cl. 525/55; 526/346; 526/326; 526/328; 526/341

(57) ABSTRACT

The invention relates to a molding compound comprising UV absorbers, to a method for producing the same and to uses thereof.

The invention relates to a moulding composition with UV absorbers, a process for their preparation, and uses.

Because UV radiation often leads to undesired decomposition reactions, UV-absorbent additives are often used in plastics. These absorb in the UV region of the spectrum and thus protect either the polymer itself or other constituents of the plastic or a material situated thereunder from reactions of this type. These UV absorbers also have a number of disadvantages alongside their advantageous protective function. For example, their absorption band extends into the visible region, and portions of visible violet and blue light are therefore absorbed, thus giving the plastic a yellowish shade. This is all the more unsatisfactory since only a small portion of the UV absorber used is actually needed for the protective function. By way of example, this is the case when a transparent component is composed of a UV-stabilized moulding composition but, as a result of the absorption of the stabilizer, UV light can penetrate only the uppermost layers. The UV absorber situated at lower levels has absolutely no stabilizing function, but contributes to the increase of yellowness index by virtue of its absorption as described above in the visible region.

An established solution for this problem is coating of the component either with a lacquer layer or with a coextruded moulding composition layer which comprises a UV absorber. Frequently, however, technical reasons prevent manufacture of this type of protective layer, or economic reasons make the additional process step undesirable.

Lee et al. [Polymer Degradation and Stability 83 (2004) 435] describe polyphenyl acrylate and poly(p-methyl-phenyl acrylate) as UV stabilizer for PET. They use homopolymers of the monomers mentioned, mix these with the PET, and process the mixtures with spincoating films and fibres. The mixtures used were non-transparent, and for this reason there was also no study of absorption in the UV or visible region.

Fundamental research by Li et al. [Macromolecules 10 (1977) 840] studies the photo-Fries rearrangement of pure polyphenyl acrylate in the solid phase. No mention is made of copolymerization with MMA or of utilizing the absorption for UV stabilization.

US 2003180542, EP 1115792 B1 and EP 939093 B1 describe the use of groups having photo-Fries capability as pre-UV absorbers in polyesters and in polycarbonates. Resorcinol is included as diol component here in the main chain. These patents do not mention poly(meth)-acrylates.

EP 120608 describes polymers for coating applications which are prepared via the reaction of the OH group of resorcinol monobenzoate with reactive groups of a polymer. Polymers which contain glycidyl methacrylate are reacted in the examples. Under UV light, the resorcinol monobenzoate group can undergo conversion in a photo-Fries rearrangement to give the o-hydroxybenzo-phenone group, which is an effective UV absorber.

However, the process described has serious disadvantages: the preparation of the polymers with pre-UV absorber can take place only by a polymer-analogous route, because an appropriate methacrylic ester would suppress the free-radical polymerization reaction because it acts as a free-radical scavenger. The polymer-analogous reaction to give the desired polymer-bonded pre-UV absorber is disadvantageous because of the additional process step. Furthermore, incompletely reacted epoxy groups can undergo undesired side reactions, such as hydrolysis and crosslinking. The method described is therefore unsuitable for moulding compositions.

It was therefore an object of the invention to develop a moulding composition which develops absorption in the UV region, with the associated absorption tails in the visible region, only on exposure to UV radiation.

The object is achieved via a moulding composition, characterized in that at least one monomer A is copolymerized by a free-radical route with at least one monomer B having a pre-UV-absorber group and having, on exposure to UV light, markedly increased absorption at a wavelength of from 300 to 400 nm.

The inventive compounds can perform a photo-Fries rearrangement on exposure to UV in the solid polymer, whereupon the rearrangement product has the desired UV absorption.

Suitable monomers B are in principle any of the compounds which carry out photo-Fries rearrangements after copolymerization with monomer A on exposure to UV light. The result here is an ortho-hydroxybenzoyl structure. Preferred monomers B used are compounds having acryloyl structures or having methacryloyl structures or having styrenic structures, particularly preferably p-methylphenyl methacrylate. However, other suitable derivatives may also contain in para position, instead of a methyl group, branched or unbranched C₁-C₁₈-alkyl groups, or else —O—CH₃.

Suitable monomers A are compounds selected from the group of the monomers capable of free-radical polymerization. Particular preference is given to monomers A selected from the group of the acrylates, methacrylates, substituted or unsubstituted styrenic monomers or acrylonitrile.

The monomers B are a pre-UV absorber which has no absorption bands extending into the visible region. The yellowness index of the copolymer composed of monomer A and monomer B has been found to be not significantly poorer than the yellowness index of the pure moulding composition composed of monomer A.

Conventional materials with UV absorbers always have poorer optical properties because the absorbers affect the visible region. The UV absorption of the inventive materials takes place only in the upper layers. Because yellow coloration is always one of the measures of quality, the result is substantially better appearance.

Surprisingly, it has been found that the monomers B from the group of the compounds having acryloyl structures or having methacryloyl structures or having styrenic structures, particularly preferably p-methylenephenyl methacrylate, gives good results in copolymerization with monomers A from the group of the monomers capable of free-radical polymerization, preferably from the group of the acrylates, methacrylates, substituted or unsubstituted styrenic monomers and acrylonitrile, particularly preferably methyl methacrylate. Furthermore, the polymer has particularly good thermoplastic processability.

It has been found possible to prepare blends with excellent properties from the copolymers of monomer A and monomer B with other polymers.

It has also been found possible to carry out controlled copolymerization reactions. For example, it is possible to prepare core-shell polymers whose structure encompasses, for example, a hard core, an elastomeric middle layer and an outer shell composed of polymethyl methacrylate. The pre-UV absorber can be copolymerized into the shell and/or into the middle layer, as required.

Furthermore, linkage to the polymer has proven to be more advantageous than pure physical incorporation by mixing, because no vaporization or exudation occurs during processing. Furthermore, there is no risk of migration out of the components. A very wide variety of mouldings can therefore be produced from the inventive moulding compositions or blends. It is usual to produce semifinished products, e.g. sheets, panels, blocks, profiles, pipes, hoses, rods.

To prepare the inventive polymer matrix, at least one monomer A is copolymerized by a free-radical route, if appropriate under an inert gas, in a suitable solvent, with at least one monomer B. Conventional additives are added, examples being suitable initiators or regulators. The reaction mixture is usually heated. Other polymers can also be added to prepare blends. Once the polymerization action has ended, the polymer is precipitated with a suitable solvent, dried, and further processed. Dyes, impact modifiers and additives, e.g. flame retardants, lubricants or additives to inhibit thermo-oxidative degradation, may also be added. Mouldings or semifinished products are produced, as required by the application. The moulding compositions or blends may also be coextruded or applied to other materials.

Alongside the solution polymerization process described, other free-radical polymerization processes can also be used to prepare the inventive moulding compositions, examples being emulsion polymerization, suspension polymerization or bulk polymerization.

The inventive moulding composition has a wide field of application. It can be used in the construction sector, in motor vehicles, in rail vehicles, in aircraft, in watercraft, in spacecraft, and in the technology used in advertising. One particularly preferred field of application is provided by foils, sheets, coextruded layers on sheets, and exterior parts of motor vehicles.

The inventive moulding composition providing UV adsorption by means of photo-Fries rearrangement is a low-cost alternative to the coextrusion process, which is also intended to equip only the upper layer with UV absorber. Furthermore, substantially more complicated shapes can be produced with the inventive material.

The examples given below are given for better illustration of the present invention but are not intended to restrict the invention to the features disclosed herein.

### EXAMPLES

### Example 1

### Preparation of UV-Absorber Copolymer

0.6 g of 2,2′-azobis(isobutyronitrile) dissolved in 490.9 g of toluene is metered into 540 g of methyl methacrylate, 60 g of 4-methylphenyl methacrylate and 1.38 g of methyl 3-mercaptopropionate under argon at 98° C. within a period of 360 min. Stirring is continued for 60 min, and the mixture is then cooled to about 50° C. and diluted with 329.1 g of toluene (100% conversion, V.N.=46.3 ml/g).

The polymer is precipitated in methanol and dried (vac., 120° C., 4 h) and processed to give a pressed sheet of thickness 1 mm (processing temperature: 180° C.).

The pressed sheet is irradiated at a rate of 60 W/m² (measured in the wavelength range from 300 to 400 nm) in a Suntest CPS/10 (ATLAS Material Testing Technology GmbH, D-63589 Linsengericht-Altenhaβlau) and tested after the irradiation times listed in the table below. Yellowness index is determined to DIN 6167 (D65/10°).

| Irradiation time [h] | 0 | 24 | 48 | 96 | 144 | 216 | 288 |
|---|---|---|---|---|---|---|---|
| Total | 91.27 | 91.66 | 91.62 | 91.41 | 91.41 | 91.28 | 91.10 |
| transmittance | | | | | | | |
| [%] | | | | | | | |
| Yellowness | 1.68 | 1.29 | 1.39 | 1.64 | 1.77 | 2.15 | 2.43 |
| index (D65/10) | | | | | | | |
| Transmittance | 81.38 | 51.18 | 42.48 | 36.32 | 34.66 | 32.58 | 31.04 |
| at 335 nm [%] | | | | | | | |

1. A moulding composition, wherein at least one monomer A is copolymerized by a free-radical route with at least one monomer B having a pre-UV-absorber group and having, on exposure to UV light, markedly increased absorption at a wavelength of from 300 to 400 nm.

2. The moulding composition according to claim 1, wherein the monomer B forms, after copolymerization with monomer A with exposure to UV light, an ortho-hydroxybenzoyl structure through photo-Fries rearrangement.

3. The moulding composition according to claim 1, wherein the monomer B contains an acryloyl structure or methacryloyl structure or styrenic structure.

4. The moulding composition according to claim 1, wherein the monomer B is p-methyl-phenyl methacrylate.

5. The moulding composition according to claim 1, wherein the monomer A has been selected from the group of the monomers capable of free-radical polymerization.

6. The moulding composition according to claim 5, wherein the monomer A has been selected from the group of the acrylates, methacrylates, substituted or unsubstituted styrenic monomers and acrylonitrile.

7. A blend composed of a moulding composition according to claim 1 and of at least one other polymer.

8. A moulding produced from a moulding composition according to claim 1.

9. A process for preparation of a moulding composition according to claim 1, wherein at least one monomer A is copolymerized with at least one monomer B by a free-radical route.

10-11. (canceled)

12. A method for improving UV-characteristics of a polymer comprising admixing a moulding composition of claim 1 with a plastic used in the construction sector, in motor vehicles, in rail vehicles, in watercraft, in aircraft, in spacecraft, and in the technology used in advertising.

13. The method of claim 12, wherein the molding composition is added to foils, sheets, coextruded layers on sheets and exterior parts of motor vehicles.
